(19) United States
(12) Patent Application Publication
(10) Pub. No.: US 2017/0350376 A1
(43) Pub. Date: Dec. 7, 2017

(54) HYDRAULIC PUMP

(71) Applicant: HYUNDAI CONSTRUCTION EQUIPMENT, Seongnam-si, Gyeonggi-do (KR)

(72) Inventors: Byoung Ik KANG, Ulsan (KR); Seong Choon LEE, Ulsan (KR); Byoung Choon MOON, Ulsan (KR); Jun Yeon CHO, Ulsan (KR)

(21) Appl. No.: 15/537,643

(22) PCT Filed: Sep. 3, 2015
(86) PCT No.: PCT/KR2015/009314

§ 371 Date: Jun. 19, 2017

(30) Foreign Application Priority Data
Dec. 19, 2014 (KR) 10-2014-0184531

(51) Int. Cl. F04B 1/12; F04B 51/00; F04B 1/14; F04B 1/16; F04B 1/29; F15B 11/08

(52) U.S. Cl. CPC F04B 1/122; F04B 1/16; F04B 1/295; F04B 51/00; F04B 1/146; F15B 2211/20553; F15B 2211/20576; F15B 2211/40; F15B 11/08

(57) ABSTRACT

In the hydraulic pump according to the present invention, a straight path among the paths, through which the fluid flows within the hydraulic pump, and a connection point on the straight path are formed to have curvatures, so that it is possible to prevent stress from being concentrated to the connection point, thereby improving durability, and it is possible to manufacture the hydraulic pump by forming a casting shape with a curvature in advance, thereby decreasing additional machining and decreasing costs of a product.

### TECHNICAL FIELD

The present invention relates to a hydraulic pump.

### BACKGROUND ART

A hydraulic pump is a basic power source of a hydraulic system which receives mechanical energy obtained by a motor, an engine, and the like and supplies fluid energy with a pressure and a flow rate to a fluid to operate a hydraulic motor or a cylinder. The hydraulic pump includes a fixed displacement pump (a pump of which the discharged quantity of fluid per rotation cannot be changed) and a variable displacement pump (a pump of which the discharged quantity of fluid per rotation can be changed), but the fixed displacement pump is generally used.

The fixed displacement pump takes in and discharges a fluid by a change in a flow rate of a sealed chamber, and includes an inlet side and an outlet side which are isolated from each other, so that even though a load is changed and a discharge pressure of the pump is changed, the quantity of fluid discharged of the pump is almost uniform, and thus, the fixed displacement pump is appropriate to an apparatus using hydraulic pressure.

The fixed displacement pump has a disadvantage in that when revolutions per minute (RPM) of an engine is increased, a flow rate of the fluid is proportionally increased, so that a flow rate is generated more than needs in a high engine RPM region to increase a pressure of a fluid driving system, and an output of the engine needs to be additionally used for driving the pump due to the increased pressure.

Accordingly, in order to supplement the disadvantage by preventing power loss due to the generation of the unnecessary fluid pressure and improving fuel efficiency, currently, the variable displacement pump which adjusts a flow rate of a pump according to an engine RPM has been mainly used.

In the variable displacement pump which is a pump which is capable of changing a capacity of the pump from a minimum level to a maximum level, when a cylinder itself rotates within a case of the pump according to a rotation of a pump shaft, a piston rotatably reciprocates together with the cylinder, and a stroke of the piston is changed according to an inclination of an inclined plate, so that the quantity of fluid discharged from the pump is changed.

However, in spite of the use of the variable displacement pump, durability of the variable displacement pump is easily degraded by an operation of compressing the fluid with high pressure and discharging the fluid, so that lots of maintenance and repair are required, thereby increasing maintenance and repair costs.

### DISCLOSURE

### Technical Problem

The present invention is conceived to solve the aforementioned problems. Accordingly, an object of the present invention is to provide a hydraulic pump which decreases stress applied to an internal component of the pump by a high pressure fluid to improve durability and safety, and decreases the amount of additional machining after casting to decrease manufacturing costs.

### Technical Solution

According to an aspect of the present invention, there is provided a hydraulic pump, including: a first hydraulic pump which is provided at one side and compresses a fluid; a second hydraulic pump which is provided at the other side and compresses a fluid; and a valve block provided between the first hydraulic pump and the second hydraulic pump, wherein the valve block includes one or more fluid paths through which the fluid compressed in the first hydraulic pump or the second hydraulic pump flows inside the valve block, the fluid paths include: one or more first paths which have at least parts having straight sections; and one or more second paths having only curve sections, and a branch point formed in the fluid path is connected to a curve surface having a curvature.

Specifically, any one first path may be branched only from another first path.

Specifically, the second path may be branched only from any one first path.

Specifically, the fluid path may include: a main fluid discharge path that is the first path which discharges the fluid compressed in the first hydraulic pump or the second hydraulic pump to the outside inside the fluid path; a first sub fluid discharge path that is the first path which is branched from the fluid discharge path and discharges the fluid compressed in the first hydraulic pump or the second hydraulic pump to a first device using the compressed fluid; and a second sub fluid discharge path that is the second path which is branched from the first sub fluid discharge path and discharges at least a part of the fluid flowing the first sub fluid discharge path to a second device using the compressed fluid, and a point, at which the main fluid discharge path and the first sub fluid discharge path are branched, and a point, at which the first sub fluid discharge path and the second sub fluid discharge path are branched, have a gentle curvature.

Specifically, the main fluid discharge path may include: a kidney hole connected with the first hydraulic pump or the second hydraulic pump; a discharge hole connected with the outside; and a connection part which connects the kidney hole and the discharge hole, and a point, at which the kidney hole and the connection part are connected, has a gentle curvature.

Specifically, the first device may be a sensor measuring a pressure of the fluid compressed in the first hydraulic pump or the second hydraulic pump, and the second device may be a regulator adjusting an inclination angle of a swash plate adjusting a discharge flow rate of the first hydraulic pump or the second hydraulic pump.

Specifically, the main fluid discharge path may supply the compressed fluid to a main device using the fluid compressed in the first hydraulic pump or the second hydraulic pump, and the main device may be a working device of construction equipment.

### Advantageous Effects

In the hydraulic pump according to the present invention, two discharge holes, through which a fluid compressed with a high pressure is discharged, are disposed vertically, not horizontally, thereby decreasing the size of the hydraulic pump and maximizing space utilization, and improving bolt fastening safety between the valve block and the left and right hydraulic pumps.

Further, in the hydraulic pump according to the present invention, the path, through which the fluid is supplied to the regulator, is disposed so as to be branched from the straight path, through which the fluid is supplied to the sensor, so that the number of branch points (path intersections) in the fluid discharge path is decreased to one, thereby improving durability, and the path is branched from the straight path and thus stress applied to the branch point is further decreased, thereby maximizing durability safety.

Further, in the hydraulic pump according to the present invention, predetermined gaps from the kidney holes are formed in symmetric sections, and sections from the predetermined sections to the fluid discharge hole are formed in gentle curve sections, so that it is possible to effectively decrease the size of stress applied to the fluid discharge path, thereby improving durability, and it is possible to decrease additional machining after casting, thereby decreasing costs of a product.

Further, in the hydraulic pump according to the present invention, the straight among the paths, through which the fluid flows within the hydraulic pump, and the connection point on the straight path are formed to have curvatures, so that it is possible to prevent stress from being concentrated to the connection point, thereby improving durability, and it is possible to manufacture the hydraulic pump by forming a casting shape with a curvature in advance, thereby decreasing additional machining and decreasing costs of a product.

### BRIEF DESCRIPTION OF THE DRAWINGS

FIG. 1 is a cross-sectional view illustrating a hydraulic pump.

FIG. 2A is a perspective view illustrating a valve block of a hydraulic pump according to a first exemplary embodiment of the present invention.

FIG. 2B is a rear view illustrating the valve block of the hydraulic pump according to the first exemplary embodiment of the present invention.

FIG. 3A is a conceptual diagram illustrating an internal side of a valve block of a hydraulic pump according to a second exemplary embodiment of the present invention.

FIG. 3B is a conceptual diagram illustrating a kidney hole of the valve block of the hydraulic pump according to the second exemplary embodiment of the present invention.

FIG. 4A is a conceptual diagram illustrating an internal side of a valve block of a hydraulic pump in the related art.

FIG. 4B is a conceptual diagram illustrating an internal side of a valve block of a hydraulic pump according to a third exemplary embodiment of the present invention.

FIG. 5A is a conceptual diagram illustrating a connection state of a main fluid discharge path and a sensor fluid supply path of a valve block of a hydraulic pump according to a fourth exemplary embodiment of the present invention.

FIG. 5B is a conceptual diagram illustrating a connection state between the sensor fluid supply path and a regulator fluid supply path of the valve block of the hydraulic pump according to the fourth exemplary embodiment of the present invention.

FIG. 6A is a diagram illustrating a structure analysis result representing a state of stress which is applied to a kidney hole when the hydraulic pump in the relate art is driven.

FIG. 6B is a diagram illustrating a structure analysis result representing a state of stress which is applied to the kidney hole when the hydraulic pump according to the exemplary embodiment of the present invention is driven.

### MODE FOR THE INVENTION

Objects, specific advantages, and new features of the present invention will become more apparent based on the relevant detailed description and the exemplary embodiments related to the accompanying drawings. In the present specification, it should note that in giving reference numerals to elements of each drawing, like reference numerals refer to like elements even though like elements are shown in different drawings. Further, in the description of the present disclosure, a detailed explanation of related publicly known arts is omitted when it is determined that the detailed explanation unnecessarily makes the subject matter of the present disclosure obscure.

Hereinafter, an exemplary embodiment of the present invention will be described in detail with reference to the accompanying drawings.

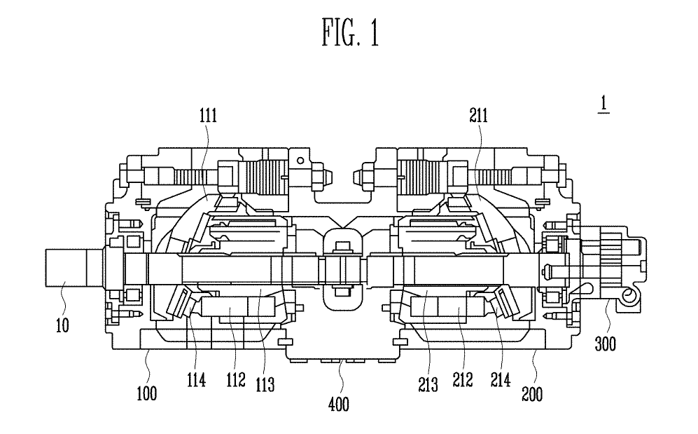

FIG. 1 is a cross-sectional view illustrating a hydraulic pump. Before describing an exemplary embodiment of the present invention, a hydraulic pump 1 will be schematically illustrated below. The hydraulic pump 1 illustrated in FIG. 1 is a two-stage variable flow rate piston type pump, which is, however, simply one example for describing the hydraulic pump 1 according to the exemplary embodiment of the present invention, but is not limited thereto.

As illustrated in FIG. 1, the hydraulic pump 1 includes a driving shaft 10, a first hydraulic pump 100, a second hydraulic pump 200, a pilot pump 300, and a valve block 400.

The hydraulic pump 1 is formed of the first hydraulic pump 100 which is provided at one side to compress a fluid, and the second hydraulic pump 200 which is provided at the other side to compress a fluid, that is, the first hydraulic pump 100 and the second hydraulic pump 200 which are two bilaterally symmetric piston pumps. In this case, the valve block 400 may be positioned between the first hydraulic pump 100 and the second hydraulic pump 200 to couple the first hydraulic pump 100 and the second hydraulic pump 200 to each other.

The first hydraulic pump 100 and the second hydraulic pump 200 include cylinder blocks 113 and 213, into which a plurality of pistons 112 and 212 is radially inserted, and swash plates 111 and 211 which are in close contact with piston shoes 114 and 214 connected with the pistons 112 and 213 and are capable of adjusting maximum and minimum flow rates therein, include screws (of which reference numerals are not denoted) adjusting angles of the swash plates 111 and 211, and a driving shaft 10 passes through the cylinder blocks 113 and 213 and the swash plates 111 and 211.

The swash plates 111 and 211 do not rotate and are fixed with predetermined angles, and when the pistons 112 and 212 rotates by a rotation of the driving shaft 10, the pistons 112 and 212 slide along the swash plates 111 and 211 and reciprocate in the shaft direction within cylinders of the cylinder blocks 113 and 213.

The first hydraulic pump 100 and the second hydraulic pump 200 are connected and fixed by the valve block 400, and in this case, the first hydraulic pump 100 and the second hydraulic pump 200 are coupled by bolt fastening. The valve block 400 may supply a fluid flow into each of the pumps 100 and 200, and discharge a fluid compressed and discharged from each of the pumps 100 and 200 to the outside.

The pilot pump 300 refers to a pump for circulating a fluid in a pilot circuit (not illustrated). The pilot pump 300 is positioned at one side (preferably, a right side) of the second hydraulic pump 200, and may be a gear type pump.

Hereinafter, the contents of the improved present invention will be described in detail based on the foregoing hydraulic pump 1.

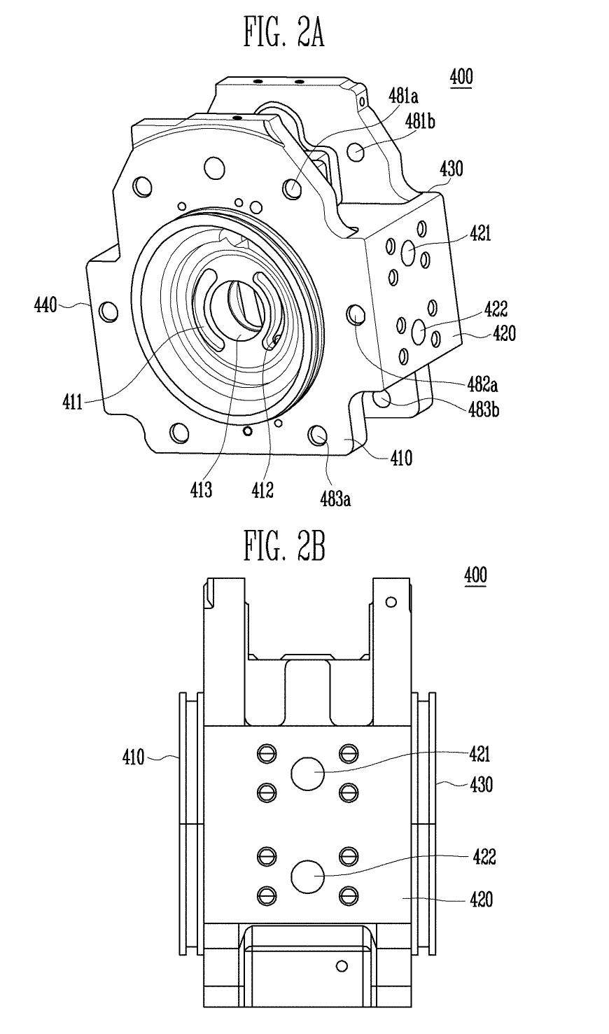

FIG. 2A is a perspective view illustrating a valve block of a hydraulic pump according to a first exemplary embodiment of the present invention, and FIG. 2B is a rear view illustrating the valve block of the hydraulic pump according to the first exemplary embodiment of the present invention.

As illustrated in FIGS. 2A and 2B, a valve block 400 of a hydraulic pump 1 according to the first exemplary embodiment of the present invention includes a valve block right surface portion 410, a valve block rear surface portion 420, a valve block left surface portion 430, and a valve block front surface portion 440.

The hydraulic pump 1 according to the present invention uses the same reference numeral as that of each configuration of the hydraulic pump 1 described with reference to FIG. 1 for convenience of the description, but the same reference numeral is not essentially refer to the same configuration.

The valve block right surface portion 410 may be positioned in a right surface of the valve block 400, and may be connected with the second hydraulic pump 200. The valve block right surface portion 410 has a center portion through which the driving shaft 10 passes, is a surface which is in contact with the second hydraulic pump 200, and is formed to be connected with the elements (for example, the cylinder block 213, or a valve plate (of which a reference numeral is omitted)) of the second hydraulic pump 200.

Particularly, in the valve block right surface portion 410, a driving shaft through-hole 413, through which the driving shaft 10 passes, is formed in the center portion, and an intake-side second kidney hole 411 is formed at one side of the driving shaft through-hole 413, and a discharge-side second kidney hole 412 is formed at the other side of driving shaft through-hole 413. The intake-side second kidney hole 411 is a hole for supplying a fluid to the second hydraulic pump 200 from the outside (preferably, a hydraulic storage tank (not illustrated)), and the discharge-side second kidney hole 412 is a hole for discharging a fluid compressed in the second hydraulic pump 200 to the outside (preferably, a working device (not illustrated) using the compressed fluid).

The valve block right surface portion 410 may include a second hydraulic pump-first bolting fastening part 481a for engaging an upper portion of the valve block 400, a second hydraulic pump-second bolting fastening part 482a for engaging a center portion of the valve block 400, and a second hydraulic pump-third bolting fastening part 483a for engaging a lower portion of the valve block 400, in order to engage the second hydraulic pump 200 with the valve block 400.

In this case, the second hydraulic pump-second bolting fastening part 482a may be positioned between a first hydraulic pump fluid discharge hole 421 and a second hydraulic pump fluid discharge hole 422 which are formed in the valve block rear surface portion 420 to be described below.

The valve block rear surface portion 420 is positioned at an opposite side of the valve block front surface portion 440 to be described below, that is, a rear surface of the valve block 400, and may discharge the fluids compressed in the first hydraulic pump 100 and the second hydraulic pump 200 to the outside (preferably, the working device using the compressed fluid).

The valve block rear surface portion 420 may include a first hydraulic pump fluid discharge hole 421 discharging the fluid compressed in the first hydraulic pump 100 to the outside, and a second hydraulic pump fluid discharge hole 422 discharging the fluid compressed in the second hydraulic pump 200 to the outside.

In this case, the first hydraulic pump fluid discharge hole 421 may be formed to be positioned at an upper side of the valve block rear surface portion 420, and the second hydraulic pump fluid discharge hole 422 may be formed to be positioned at a lower side of the valve block rear surface portion 420. This means that the first hydraulic pump fluid discharge hole 421 may be positioned while being vertically spaced apart from the second hydraulic pump fluid discharge hole 422, and the present invention is not essentially limited to the case where the first hydraulic pump fluid discharge hole 421 is positioned at the upper side and the second hydraulic pump fluid discharge hole 422 is positioned at the lower side.

The first hydraulic pump fluid discharge hole 421 and the second hydraulic pump fluid discharge hole 422 may be provided at positions which are vertically symmetric to each other based on the center of the valve block rear surface portion 420, particularly, positions which are axisymmetric to each other based on a center line which vertically bisects the valve block rear surface portion 420.

In the related art, a first hydraulic pump fluid discharge hole and a second hydraulic pump fluid discharge hole are provided at left and right positions on a horizontal line, so that there is a problem in that a length of a valve block is increased to increase an entire length of a hydraulic pump, but in the present invention, the first hydraulic pump fluid discharge hole 421 and the second hydraulic pump fluid discharge hole 422 are provided at the upper and lower positions as described above, so that it is possible to decrease an entire size of the hydraulic pump 1 (particularly, a horizontal length of the hydraulic pump 1 is effectively decreased), thereby achieving an effect in maximizing space utilization of machines (preferably, construction equipment (not illustrated)) driven with a hydraulic pressure.

The first hydraulic pump fluid discharge hole 421 and the second hydraulic pump fluid discharge hole 422 may be formed to be spaced apart from each other at the upper side and the lower side so that bolting fastening parts (a first hydraulic pump-second bolting fastening part (not illustrated) and the second hydraulic pump-second bolting fastening part 482a) for engaging the first hydraulic pump 100 and the second hydraulic pump 200 with the valve block 400 are formed in the valve block right surface portion 410 and the valve block left surface portion 430.

That is, the first hydraulic pump-second bolting fastening part and the second hydraulic pump-second bolting fastening part 482a may be formed between the first hydraulic pump fluid discharge hole 421 and the second hydraulic pump fluid discharge hole 422.

In the related art, the first hydraulic pump fluid discharge hole and the second hydraulic pump fluid discharge hole are provided at the left and right positions on the horizontal line, and thus a bolting fastening part for engaging the first hydraulic pump 100 and the second hydraulic pump 200 cannot be formed in a valve block rear surface portion, so that there is a problem in that engaging force of the first hydraulic pump 100 and the second hydraulic pump 200 is weak.

Accordingly, in the first exemplary embodiment of the present invention, an available space, in which the first hydraulic pump-second bolting fastening part and the second hydraulic pump-second bolting fastening part 482a may be formed, is generated between the first hydraulic pump fluid discharge hole 421 and the second hydraulic pump fluid discharge hole 422, so that the larger number of bolting fastening parts, which are capable of engaging the first hydraulic pump 100 and the second hydraulic pump 200, than that of the related art is formed (in the exemplary embodiment of the present invention, the six bolting fastening parts are formed so as to engage the center side of the valve block 400, as well as the upper side and the lower side of the valve block 400), thereby achieving an effect in maximizing engagement force of the first hydraulic pump 100 and the second hydraulic pump 200.

The valve block left surface portion 430 may be positioned in a left surface of the valve block 400, and may be connected with the first hydraulic pump 100. The valve block left surface portion 430 has a center portion through which the driving shaft 10 passes, is a surface which is in contact with the first hydraulic pump 100, and is formed to be connected with the elements (for example, the cylinder block 113, or a valve plate (of which a reference numeral is omitted)) of the first hydraulic pump 100.

Particularly, in the valve block left surface portion 430, a driving shaft through-hole (not illustrated), through which the driving shaft 10 passes, is formed in the center portion, and an intake-side first kidney hole (not illustrated) is formed at one side of the driving shaft through-hole, and a discharge-side first kidney hole (not illustrated) is formed at the other side of the driving shaft through-hole. The intake-side first kidney hole is a hole for supplying a fluid to the first hydraulic pump 100 from the outside (preferably, a hydraulic storage tank (not illustrated)), and the discharge-side first kidney hole is a hole for discharging the fluid compressed in the first hydraulic pump 100 to the outside (preferably, a working device (not illustrated) using the compressed fluid).

The valve block left surface portion 430 may include a first hydraulic pump-first bolting fastening part 481b for engaging the upper portion of the valve block 400, a first hydraulic pump-second bolting fastening part (not illustrated) for engaging the center portion of the valve block 400, and a first hydraulic pump-third bolting fastening part 483b for engaging the lower portion of the valve block 400, in order to engage the first hydraulic pump 100 with the valve block 400.

In this case, the first hydraulic pump-second bolting fastening part may be positioned between the first hydraulic pump fluid discharge hole 421 and the second hydraulic pump fluid discharge hole 422 which are formed in the valve block rear surface portion 420.

The valve block front surface portion 440 is positioned at the opposite side of the valve block rear surface portion 420, that is, a front surface of the valve block 400, and may receive a fluid from the outside (preferably, a pressurized oil storage tank) and supply the received fluid to the first hydraulic pump 100 and the second hydraulic pump 200.

Particularly, the valve block front surface portion 440 may include a fluid inflow path 441 through which a fluid is received to be supplied to the first hydraulic pump 100 and the second hydraulic pump 200, and the fluid inflow path 441 may be formed at the center of the valve block front portion 440 in a form of a through-hole to be connected with the intake-side first kidney hole and the intake-side second kidney hole 411.

As described above, in the hydraulic pump 1, the two discharge holes 421 and 422, through which the fluids compressed with high pressure are discharged, are vertically disposed, not horizontally, so that there is an effect in maximizing space utilization by decreasing the size of the hydraulic pump 1 and increasing safety in the bolt fastening between the valve block 400 and the left and right hydraulic pumps 100 and 200.

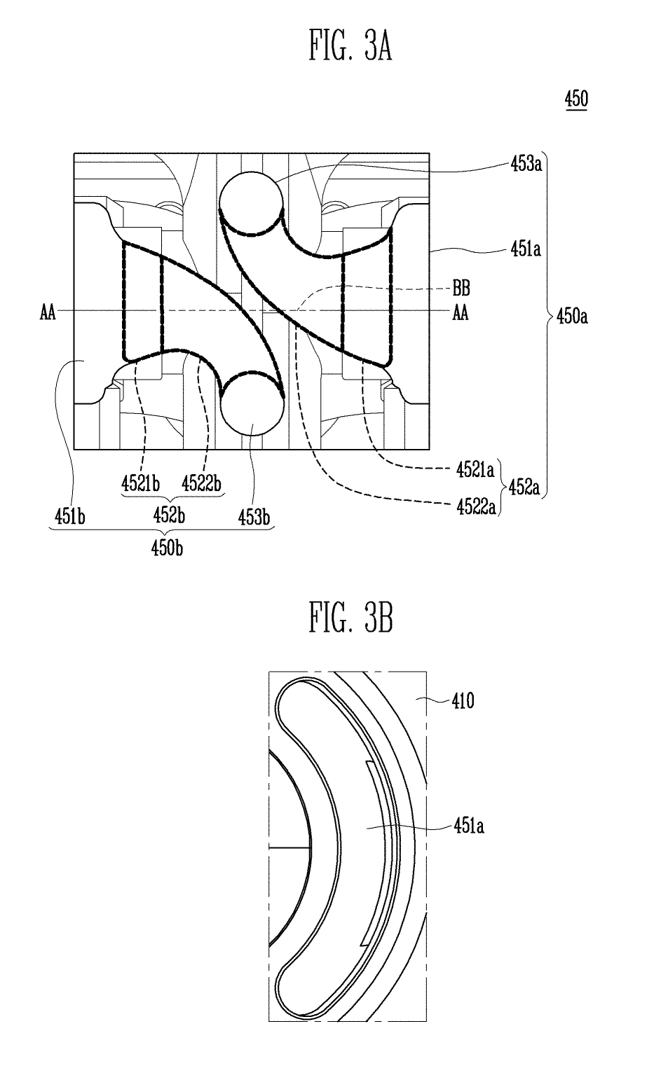

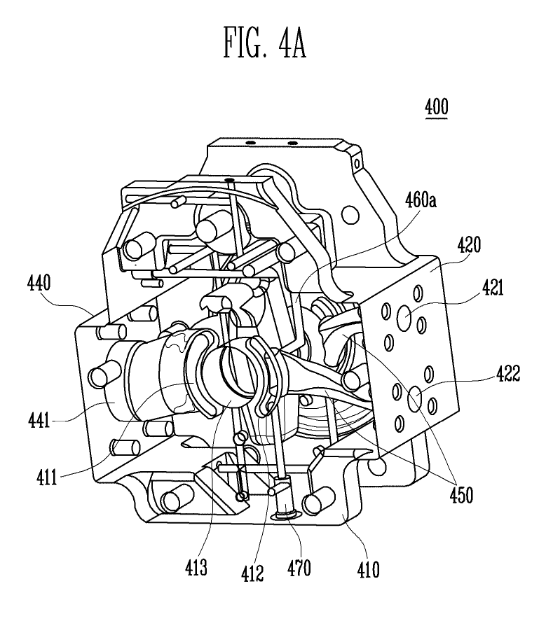

FIG. 3A is a conceptual diagram illustrating an internal side of a valve block of a hydraulic pump according to a second exemplary embodiment of the present invention, and FIG. 3B is a conceptual diagram illustrating a kidney hole of the valve block of the hydraulic pump according to the second exemplary embodiment of the present invention.

As illustrated in FIGS. 3A and 3B, the valve block 400 of the hydraulic pump 1 according to the second exemplary embodiment of the present invention includes a fluid discharge path 450.

The hydraulic pump 1 according to the present invention uses the same reference numeral as that of each configuration of the hydraulic pump 1 described with reference to FIGS. 1 and 2 for convenience of the description, but the same reference numeral is not essentially refer to the same configuration.

The valve block 400 of the hydraulic pump 1 according to the exemplary embodiment of the present invention includes the fluid discharge path 450, through which a fluid compressed in the first hydraulic pump 100 or the second hydraulic pump 200 is discharged to the outside (preferably, a working device using a compressed fluid, hereinafter, the outside in the second exemplary embodiment of the present invention refers to the same) therein.

The fluid discharge path 450 includes a first fluid discharge path 450a through which the fluid compressed in the first hydraulic pump 100 is discharged to the outside, and a second fluid discharge path 450b through which the fluid compressed in the second hydraulic pump 200 is discharged to the outside.

The first fluid discharge path 450a may include a discharge-side first kidney hole 451a connected with the first hydraulic pump 100, a first discharge hole 453a connected with the outside and provided at an upper side based on a center line CC which vertically bisects the valve block 400, and a first connecting part 452a connecting the first kidney hole 451a and the first discharge hole 453a.

The discharge-side first kidney hole 451a is a space through which the fluid compressed in the first hydraulic pump 100 flows into the first fluid discharge path 450a, is formed in a similar shape to that of a kidney of a person, and is connectable with the first connecting part 452a.

The first connecting part 452a may be continuously formed so that the discharge-side first kidney hole 451a is connected with the first discharge hole 453a, and may include a first connection first part 4521a, in which a curvature direction of an upper curve is formed to be opposite to a curvature direction of a lower curve, and a first connection second part 4522a, in which a curvature direction of an upper curve is formed to be equal to a curvature direction of a lower curve.

Particularly, the first connection first part 4521a may be formed to be vertically symmetric based on a center line BB which vertically bisects the first connection first part 4521a, may be provided between the discharge-side first kidney hole 451a and the first connection second part 4522a, and may occupy a region of 30% to 40% of a region of the first connecting part 452a, and the first connection second part 4522a may be provided between the first connection first part 4521a and the first discharge hole 453a and may connect the first connection first part 4521a and the first discharge hole 453a.

The second fluid discharge path 450b may include a discharge-side second kidney hole 451b connected with the second hydraulic pump 200, a second discharge hole 453b connected with the outside and provided at a lower side based on the center line CC which vertically bisects the valve block 400, and a second connecting part 452b connecting the second kidney hole 451b and the second discharge hole 453b.

The discharge-side second kidney hole 451b is a space through which the fluid compressed in the second hydraulic pump 200 flows into the second fluid discharge path 450b, is formed in a similar shape to that of a kidney of a person, and is connectable with the second connecting part 452b.

The second connecting part 452b may be continuously formed so that the discharge-side second kidney hole 451b is connected with the second discharge hole 453b, and may include a second connection first part 4521b, in which a curvature direction of an upper curve is formed to be opposite to a curvature direction of a lower curve, and a second connection second part 4522b, in which a curvature direction of an upper curve is formed to be equal to a curvature direction of a lower curve.

Particularly, the second connection first part 4521b may be formed to be vertically symmetric based on the center line BB which vertically bisects the second connection first part 4521b, may be provided between the discharge-side second kidney hole 451b and the second connection second part 4522b, and may occupy a region of 30% to 40% of a region of the second connecting part 452b, and the second first connection second part 4522b may be provided between the second connection first part 4521b and the second discharge hole 453b and may connect the second connection first part 4521b and the second discharge hole 453b.

As described above, the fluid discharge path 450 formed inside the valve block 400 is formed in a shape, in which at least a part of the fluid discharge path 450 is vertically symmetric based on the center line BB vertically bisects the fluid discharge path 450, so that it is possible to effectively decrease a size of stress applied to the fluid discharge path 450, thereby achieving an effect in maximizing durability of the hydraulic pump 1.

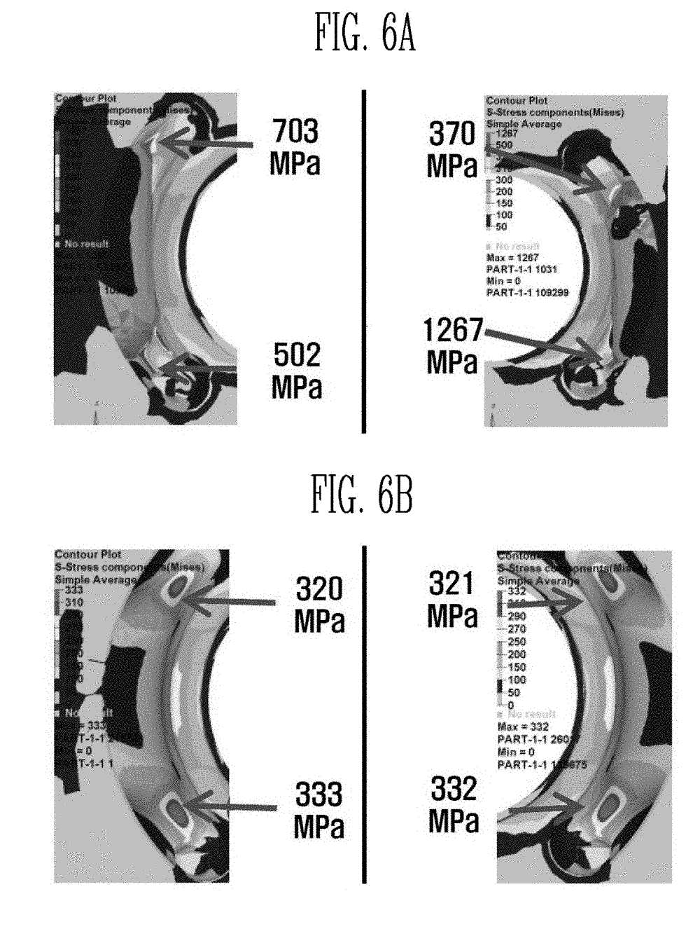

Experimental data which may draw the foregoing effects will be described with reference to FIG. 6.

FIG. 6A is a diagram illustrating a structure analysis result representing a state of stress which is applied to a kidney hole when the hydraulic pump in the relate art is driven, and FIG. 6B is a diagram illustrating a structure analysis result representing a state of stress which is applied to the kidney hole when the hydraulic pump according to the exemplary embodiment of the present invention is driven.

FIGS. 6A and 6B represent that the degree of stress concentration is increased from a center of the drawing in an arrow direction. In FIGS. 6A and 6B, a left side is a structure analysis result of the discharge-side first kidney hole 451a receiving stress by the fluid discharged from the first hydraulic pump 100, and a right side is a structure analysis result of the discharge-side second kidney hole 451b receiving stress by the fluid discharged from the second hydraulic pump 200.

Referring to the left drawing of FIG. 6A, stress applied to the discharge-side first kidney hole by the first hydraulic pump in the related art is 703 MPa at an upper side and 502 MPa at a lower side, so that the large stress is drawn, but in the exemplary embodiment of the present invention, referring to the left drawing of FIG. 6B, stress applied to the discharge-side first kidney hole 451a by the first hydraulic pump 100 is 320 MPa at an upper side and 333 MPa at a lower side, so that it can be seen that stress is definitely decreased.

Further, referring to the right drawing of FIG. 6A, stress applied to the discharge-side first kidney hole 451a by the second hydraulic pump 200 in the related art is 370 MPa at the upper side and 1,267 MPa at the lower side, so that the large stress is drawn, but in the exemplary embodiment of the present invention, referring to the right drawing of FIG. 6B, stress applied to the discharge-side first kidney hole 451a by the second hydraulic pump 200 is 321 MPa at the upper side and 332 MPa at the lower side, so that it can be seen that stress is remarkably decreased.

That is, referring to the data illustrated in FIGS. 6A and 6B, it can be drawn the fact that the size of stress applied to the discharge-side first kidney hole 451a is decreased, so that durability of the hydraulic pump 1 according to the exemplary embodiment of the present invention is enhanced, and risk of damage is decreased, so that driving reliability of the hydraulic pump 1 is improved.

As described above, in the hydraulic pump 1 according to the present invention, predetermined sections from the kidney holes 451a and 451b are formed in symmetric sections, and sections from the predetermined sections to the fluid discharge hole are formed in gentle curve sections, so that it is possible to effectively decrease the size of stress applied to the fluid discharge path 450, thereby improving durability, and it is possible to decrease additional machining after casting, thereby decreasing costs of a product.

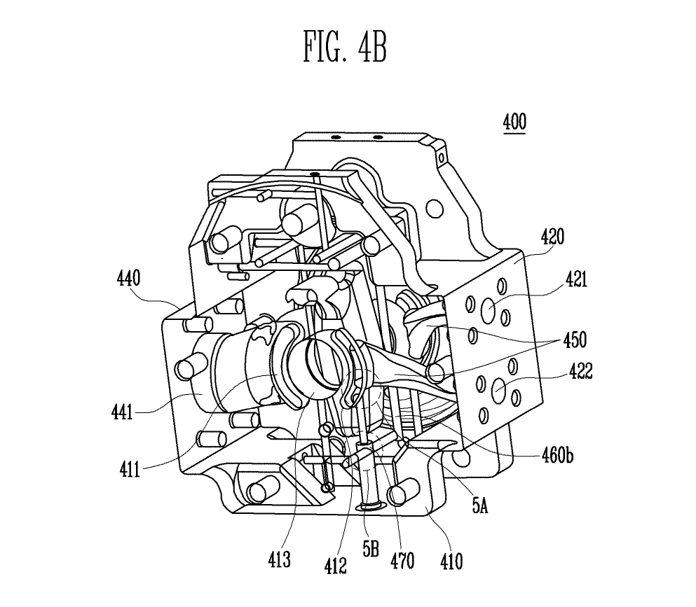

FIG. 4A is a conceptual diagram illustrating an internal side of a valve block of a hydraulic pump in the related art, and FIG. 4B is a conceptual diagram illustrating an internal side of a valve block of a hydraulic pump according to a third exemplary embodiment of the present invention.

As illustrated in FIG. 4B, a valve block 400 of a hydraulic pump 1 according to the third exemplary embodiment of the present invention includes a valve block right surface portion 410, a valve block rear surface portion 420, a valve block left surface portion 430, a valve block front surface portion 440, a fluid discharge path 450, a regulator fluid supply path 460b, and a sensor fluid supply path 470.

The valve block right surface portion 410, the valve block rear surface portion 420, the valve block left surface portion 430, and the valve block front surface portion 440 of the valve block 400 according to the present invention use the same reference numerals to those of the configurations of the hydraulic pump 1 described with reference to FIGS. 1 to 3 for convenience of the description, but the same reference numeral does not essentially refer to the same configuration.

The fluid discharge path 450 is provided inside the valve block 400 and is formed to have a curvature to discharge a fluid compressed in the first hydraulic pump 100 or the second hydraulic pump 200 to the outside (preferably, a working device using a compressed fluid, hereinafter, the outside in the second exemplary embodiment of the present invention refers to the same). The fluid discharge path 450 may be named as a main fluid discharge path, and the main fluid discharge path is written as the fluid discharge path 450 in the present exemplary embodiment.

The fluid discharge path 450 may include kidney holes 451a and 451b connected with the first hydraulic pump 100 and the second hydraulic pump 200, discharge holes 453a and 453b connected with the outside, and connecting parts 452a and 452b connecting the kidney holes 451a and 451b and the discharge holes 453a and 453b and formed in curve lines.

The fluid discharge path 450 may have one branch point. Particularly, the sensor fluid supply path 470 to be described below may be branched from the fluid discharge path 450, and the fluid discharge path 450 may be connected to a lower side based on a center line which vertically bisects the kidney holes 451a and 451b of the fluid discharge path 450.

When at least a part of the fluid is branched in a straight portion, the size of stress generated at the branch point is considerably smaller than the size of stress generated at a branch point when at least a part of the fluid is branched in a curve portion.

Accordingly, in the exemplary embodiment of the present invention, the sensor fluid supply path 470 is branched only from the lower side of the kidney holes 451a and 451b, not the curve portion in the fluid discharge path 450, so that it is possible to decrease the size of stress generated in the fluid discharge path 450 by the high pressure fluid discharged from the first hydraulic pump 100 or the second hydraulic pump 200. The experiment for the effect is illustrated in FIGS. 6A and 6B, and the contents thereof have been described in the description of the second exemplary embodiment of the present invention, so that the contents are in substitution for the description of the second exemplary embodiment of the present invention.

Particularly, referring to FIG. 4A, it can be seen that the regulator fluid supply path 460a to be described below is additionally branched from the curve portion of the fluid discharge path 450. Accordingly, the related art has the problem in that the branch point is generated in the curve portion of the fluid discharge path 450, so that the size of stress applied to the fluid discharge path 450 is very large, thereby degrading durability and degrading driving reliability of the hydraulic pump 1.

In this respect, in the present exemplary embodiment of the present invention, the sensor fluid supply path 470 is branched only from the lower side of the kidney holes 451a and 451b, not the curve portion in the fluid discharge path 450, and the regulator fluid supply path 460b is branched from the sensor fluid supply path 470, not the fluid discharge path 450, so that it is possible to decrease the size of stress generated in the fluid discharge path 450 by the high pressure fluid discharged from the first hydraulic pump 100 or the second hydraulic pump 200, thereby improving durability of the hydraulic pump 1 and maximizing driving reliability of the hydraulic pump 1.

The regulator fluid supply path 460b may be branched from the sensor fluid supply path 470 to be described below, preferably, a straight section of the sensor fluid supply path 470, and may discharge at least a part of the fluid flowing the sensor fluid supply path 470 to a second device (not illustrated) using the compressed fluid. Herein, the second device may be a regulator adjusting inclination angles of swash plates 111 and 211 adjusting discharged flow rates of the first hydraulic pump 100 and the second hydraulic pump 200. The regulator fluid supply path 460b may be named as a second sub fluid discharge path, and the second sub fluid discharge path is written as the regulator fluid supply path 460b in the present exemplary embodiment.

The regulator fluid supply path 460a according to the exemplary embodiment of FIG. 4A is branched from the fluid discharge path 450, so that the first hydraulic pump 100 or the second hydraulic pump 200 directly receives the high pressure fluid and thus a concentration of the stress is very large, and the regulator fluid supply path 460a is branched from the curve section, not the straight section, to increase the concentration of the stress according to the branch position, so that durability of the hydraulic pump 1 is degraded, and when the degradation of the durability of the hydraulic pump 1 is severe, the hydraulic pump 1 is broken.

In this respect, in the third exemplary embodiment of the present invention, the regulator fluid supply path 460b is branched from the sensor fluid supply path 470, so that the first hydraulic pump 100 or the second hydraulic pump 200 does not directly receive the high pressure fluid, and the regulator fluid supply path 460b is branched from the straight section of the sensor fluid supply path 470 to disperse the concentration of the stress and decrease a size of the stress concentration, thereby achieving an effect in improving durability and driving reliability.

At least a part of the sensor fluid supply path 470 may be straight, and may be branched from the fluid discharge path 450 and discharge the fluid compressed in the first hydraulic pump 100 or the second hydraulic pump 200 to a first device (not illustrated) using the compressed fluid. Herein, the first device may be a sensor measuring a pressure of the fluid compressed in the first hydraulic pump 100 or the second hydraulic pump 200. The sensor fluid supply path 470 may be named as a first sub fluid discharge path, and the first sub fluid discharge path is written as the sensor fluid supply path 470 in the present exemplary embodiment.

The sensor fluid supply path 470 may be branched from the lower side based on the center line which vertically bisects the kidney holes 451a and 451b of the fluid discharge path 450 and may supply the fluid compressed in the first hydraulic pump 100 or the second hydraulic pump 200 to the sensor.

As described above, in the hydraulic pump 1 according to the present invention, the path 460b, through which the fluid is supplied to the regulator, is disposed so as to be branched from the path 470, through which the fluid is supplied to the sensor, so that the number of branch points (path intersections) in the fluid discharge path 450 is decreased to one, thereby improving durability of the hydraulic pump 1, and the path 460b, through which the fluid is supplied to the regulator, is branched from the straight path of the path 470, through which the fluid is supplied to the sensor, so that stress applied to the branch point is further decreased, thereby maximizing durability and safety.

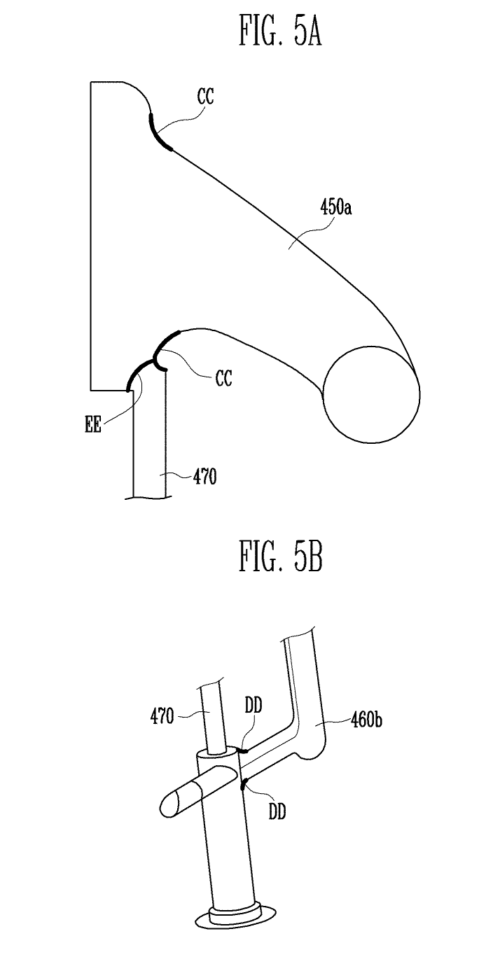

FIG. 5A is a conceptual diagram illustrating a connection state of a fluid main discharge path and a sensor fluid supply path of a valve block of a hydraulic pump according to a fourth exemplary embodiment of the present invention, and FIG. 5B is a conceptual diagram illustrating a connection state of the sensor fluid supply path and a regulator fluid supply path of the valve block of the hydraulic pump according to the fourth exemplary embodiment of the present invention.

As illustrated in FIGS. 5A and 5B, a valve block 400 of a hydraulic pump 1 according to the fourth exemplary embodiment of the present invention includes a fluid discharge path 450, a regulator fluid supply path 460b, and a sensor fluid supply path 470.

The hydraulic pump 1 according to the present invention uses the same reference numeral as that of each configuration of the hydraulic pump 1 described with reference to FIGS. 1 and 4 for convenience of the description, but the same reference numeral is not essentially refer to the same configuration.

A fluid compressed in a first hydraulic pump 100 or a second hydraulic pump 200 flows in the fluid discharge path 450. Particularly, the fluid discharge path 450 may include kidney holes 451a and 451b connected with the first hydraulic pump 100 or the second hydraulic pump 200, discharge holes 453a and 453b connected with the outside, and connecting parts 452a and 452b connecting the kidney holes 451a and 451b and the discharge holes 453a and 453b and formed in curve lines.

In the related art, points, at which the kidney holes 451a and 451b and the connecting parts 452a and 452b are connected, are formed with steps to form predetermined angles. In this case, stress by the high pressure fluid is concentrated to the connection points by the steps formed at the points, which the kidney holes 451a and 451b and the connecting parts 452a and 452b are connected, so that durability of the hydraulic pump 1 is degraded, and there is a concern in damage to the hydraulic pump 1 in a severe case.

In this respect, in the exemplary embodiment of the present invention, the points CC, at which the kidney holes 451a and 451b and the connecting parts 452a and 452b are connected, may be formed to have curvatures, that is, may be formed so that the steps are not formed. Accordingly, stress by the high pressure fluid is not concentrated and is relieved in the points CC, at which the kidney holes 451a and 451b and the connecting parts 452a and 452b are connected, so that there are effects in improving durability of the hydraulic pump 1 and maximizing driving reliability of the hydraulic pump 1.

Further, the points CC, at which the kidney holes 451a and 451b and the connecting parts 452a and 452b are connected, are formed to have curvatures, so that the hydraulic pump 1 is formed with one frame during casting, thereby achieving an effect in decreasing additional machining. Accordingly, there is an additional effect in decreasing manufacturing costs.

The fluid discharge path 450 is provided inside the valve block 400 and is formed to have a curvature to discharge a fluid compressed in the first hydraulic pump 100 or the second hydraulic pump 200 to the outside (preferably, a working device using a compressed fluid, hereinafter, the outside in the fourth exemplary embodiment of the present invention refers to the same). The fluid discharge path 450 may be a second path, in which the connection parts 452a and 452b and the discharge holes 453a and 453b have only curve sections.

The fluid discharge path 450 may be formed so as not to have a branch point in a portion having the curvature, that is, the curve section. Particularly, the fluid discharge path 450 is branched only from the lower side of the kidney holes 451a and 451b, not the curve portions, so that it is possible to decrease the size of stress generated in the fluid discharge path 450 by the high pressure fluid discharged from the first hydraulic pump 100 or the second hydraulic pump 200. The experiment for the effect is illustrated in FIGS. 6A and 6B, and the contents thereof have been described in the description of the second exemplary embodiment of the present invention, so that the contents are in substitution for the description of the second exemplary embodiment of the present invention.

The regulator fluid supply path 460b may be branched from the sensor fluid supply path 470 to be described below, preferably, a straight section of the sensor fluid supply path 470, and may discharge at least a part of the fluid flowing the sensor fluid supply path 470 to a second device (not illustrated) using the compressed fluid. Herein, the second device may be a regulator adjusting inclination angles of swash plates 111 and 211 adjusting discharged flow rates of the first hydraulic pump 100 and the second hydraulic pump 200.

Points, at which the regulator fluid supply path 460b and the sensor fluid supply path 470 are connected, that is, branch points DD branched from the straight section of the sensor fluid supply path 470, may be formed to have curvatures, that is, may be formed so as not have steps. Accordingly, stress by the high pressure fluid is not concentrated and is relieved in the points DD, at which the regulator fluid supply path 460b and the sensor fluid supply path 470 are connected, so that there are effects in improving durability of the hydraulic pump 1 and maximizing driving reliability of the hydraulic pump 1.

Further, the branch point DD branched from the straight section of the sensor fluid supply path 470 is formed to have a curvature, so that the hydraulic pump 1 is formed with one frame during casting, thereby achieving an effect in decreasing additional machining. Accordingly, there is an additional effect in decreasing manufacturing costs.

The regulator fluid supply path 460b may be a first path of which at least a part has a straight section, and may have a branch point connected with the sensor fluid supply path 470.

At least a part of the sensor fluid supply path 470 may be straight, and may be branched from the fluid discharge path 450 and discharge the fluid compressed in the first hydraulic pump 100 or the second hydraulic pump 200 to a first device (not illustrated) using a compressed fluid. Herein, the first device may be a sensor measuring a pressure of the fluid compressed in the first hydraulic pump 100 or the second hydraulic pump 200.

The sensor fluid supply path 470 may be branched from a lower side based on the center line which vertically bisects the kidney holes 451a and 451b of the fluid discharge path 450 and may supply the fluid compressed in the first hydraulic pump 100 or the second hydraulic pump 200 to the sensor.

In this case, a point EE, at which the sensor fluid supply path 470 is connected with the kidney holes 451a and 451b of the fluid discharge path 450, may be formed to have a curvature, that is, may be formed so as not to have a step. Accordingly, stress by the high pressure fluid is not concentrated and is relieved in the point EE, at which the sensor fluid supply path 470 is connected with the kidney holes 451a and 451b of the fluid discharge path 450, so that there are effects in improving durability of the hydraulic pump 1 and maximizing driving reliability of the hydraulic pump 1.

Further, a point EE, at which the sensor fluid supply path 470 is connected with the kidney holes 451a and 451b of the fluid discharge path 450, may be formed to have a curvature, so that the hydraulic pump 1 is formed with one frame during casting, thereby achieving an effect in decreasing additional machining. Accordingly, there is an additional effect in decreasing manufacturing costs.

The sensor fluid supply path 470 may be a first path of which at least a part has a straight section, and may have a branch point connected with the regulator fluid supply path 460b.

As described above, in the hydraulic pump 1 according to the present invention, the connection points CC of the kidney holes 51a and 451b and the connection parts 452a and 452b, the connection point EE connected with the straight path in the straight path, or the connection point DD of the curve path, of which at least a part has the straight section, and the straight path, in the paths 450, 460b, and 470, through which the fluid flows, within the hydraulic pump 1, are formed to have the curvatures, so that it is possible to prevent stress from being concentrated to the connection points CC, DD, and EE, thereby improving durability, and it is possible to manufacture the hydraulic pump 1 by forming a casting shape with a curvature in advance, thereby decreasing additional machining and decreasing costs of a product.

In the foregoing, the present invention has been described in detail with reference to the exemplary embodiments, but the exemplary embodiments are provided for describing the present invention in detail, and the present invention is not limited thereto, and it is apparent that those skilled in the art may modify and improve the exemplary embodiments.

The simple modification or change of the present invention belongs to the scope of the present invention, and the scope of the present invention will be obvious by the accompanying claims.

1. A hydraulic pump, comprising:
a first hydraulic pump which is provided at one side and compresses a fluid;
a second hydraulic pump which is provided at the other side and compresses a fluid; and
a valve block provided between the first hydraulic pump and the second hydraulic pump,
wherein the valve block includes one or more fluid paths through which the fluid compressed in the first hydraulic pump or the second hydraulic pump flows inside the valve block,
the fluid paths include:
one or more first paths which have at least parts having straight sections; and
one or more second paths having only curve sections, and
a branch point formed in the fluid path is connected to a curve surface having a curvature.

2. The hydraulic pump of claim 1, wherein any one first path is branched only from another first path.

3. The hydraulic pump of claim 1, wherein the second path is branched only from any one first path.

4. The hydraulic pump of claim 1, wherein the fluid path includes:
a main fluid discharge path that is the first path which discharges the fluid compressed in the first hydraulic pump or the second hydraulic pump to the outside inside the fluid path;
a first sub fluid discharge path that is the first path which is branched from the fluid discharge path and discharges the fluid compressed in the first hydraulic pump or the second hydraulic pump to a first device using the compressed fluid; and
a second sub fluid discharge path that is the second path which is branched from the first sub fluid discharge path and discharges at least a part of the fluid flowing the first sub fluid discharge path to a second device using the compressed fluid, and
a point, at which the main fluid discharge path and the first sub fluid discharge path are branched, and a point, at which the first sub fluid discharge path and the second sub fluid discharge path are branched, have a gentle curvature.

5. The hydraulic pump of claim 4, wherein the main fluid discharge path includes:
a kidney hole connected with the first hydraulic pump or the second hydraulic pump;
a discharge hole connected with the outside; and
a connection part which connects the kidney hole and the discharge hole, and
a point, at which the kidney hole and the connection part are connected, has a gentle curvature.

6. The hydraulic pump of claim 4, wherein the first device is a sensor measuring a pressure of the fluid compressed in the first hydraulic pump or the second hydraulic pump, and
the second device is a regulator adjusting an inclination angle of a swash plate adjusting a discharge flow rate of the first hydraulic pump or the second hydraulic pump.

7. The hydraulic pump of claim 4, wherein the main fluid discharge path supplies the compressed fluid to a main device using the fluid compressed in the first hydraulic pump or the second hydraulic pump, and
the main device is a working device of construction equipment.
